(19) United States
(12) Patent Application Publication
(10) Pub. No.: US 2019/0016242 A1
(43) Pub. Date: Jan. 17, 2019

(54) INTERIOR PART AND METHOD FOR MANUFACTURING THE INTERIOR PART

(71) Applicant: TOYOTA SHATAI KABUSHIKI KAISHA, Kariya-shi, Aichi (JP)

(72) Inventors: Kenji KATO, Nagoya-shi (JP); Hiroshi MAEDA, Takahama-shi (JP)

(73) Assignee: TOYOTA SHATAI KABUSHIKI KAISHA, Kariya-shi, Aichi (JP)

(21) Appl. No.: 15/754,416

(22) PCT Filed: Feb. 13, 2017
(86) PCT No.: PCT/JP2017/005054

§ 371 Date: Feb. 22, 2018

(30) Foreign Application Priority Data
Sep. 8, 2016 (JP) 2016-175939

(51) Int. Cl. B60N 2/58; B32B 7/08; B32B 7/12; B60K 37/00

(52) U.S. Cl. CPC B60N 2/5891; B32B 7/08; B32B 7/12; B32B 2605/003; B60N 2/5875; B60K 37/00; B60N 2/5883

(57) ABSTRACT

An interior part includes a base material and an outer skin material adhered to a front surface of the base material. The outer skin material includes a front surface formed with a stitch pattern of a thread inserted by engagement with a sewing needle to pass from a front surface of the outer skin material to a back surface of the base material to obliquely pass through the front surface of the base material, so that the thread forms a loop portion fixed on the back surface of the base material. The base material includes a seat surface for preventing slippage of the sewing needle on the front surface of the base material in a position where the thread of the stitch pattern is inserted.

### TECHNICAL FIELD

The present invention relates to an interior part or component including a base material and an outer skin material adhered to a front surface of the base material, in which a front surface of the outer skin material is formed with a stitch pattern, and a method for manufacturing the interior part.

### BACKGROUND ART

For instance, automobile interior parts include a base material made of rigid synthetic resin, whose front surface is covered with soft outer skin material, and a front surface of the outer skin material is applied with embossed patterns and stitch patterns sewn with a thread to enhance design appearance and impart a sense of luxury and soft texture. For example, Patent Document 1 discloses a decorative member having such a stitch pattern sewn on a base material with use of upper threads without using lower threads, and a manufacturing method of the decorative member.

Specifically, according to the manufacturing method of the decorative member described in Patent Document 1, a thread is inserted through the tip of a sewing needle and this needle with the thread is penetrated through a base material from a front surface side until the thread comes out of a back surface side. The base material is thus formed with a through hole through which the thread passes out. Thus, a motion of retracting the sewing needle to the front surface side of the base material and moving the base material by a pitch corresponding to one stitch and a motion of inserting the sewing needle again through the base material are alternately repeated to form a stitch pattern of the thread on the front surface of the base material. The stitch pattern is formed of a single thread (an upper thread) and thus a portion of the thread that comes out of the back surface of the base material forms a loop portion. After the stitch pattern is completely formed with the thread, the back surface of the base material is applied with hot melt resin, adhesive, and the like, and then the resin is solidified to embed the thread loop portion therein. In this way, a decorative member provided with the stitch pattern is produced. In other words, the decorative member provided with the stitch pattern on the base material is configured such that a thread fixed part formed of solidified hot melt resin or adhesive prevents the thread from slipping out toward the front surface of the base material.

### RELATED ART DOCUMENTS

### Patent Documents

Patent Document 1: Japanese Unexamined Patent Application Publication No. 2011-98467

### SUMMARY OF INVENTION

### Problems to be Solved by the Invention

However, a decorative member 100 in Patent Document 1 would cause the following problems. Specifically, in forming a stitch pattern on a base material 103 near its outer edge, when a sewing needle 101 is inserted through the base material 103 in a direction perpendicular to a front surface 103A as shown in FIG. 11 (a), the sewing needle 101 may interfere with an outer edge rib 103C and others formed on the outer edge of the base material 103. To avoid such interference, therefore, the sewing needle 101 has to be inserted obliquely through the front surface 103A of the base material 103 as shown in FIG. 11 (b). In this case, the tip of the sewing needle 101 is apt to slip on the front surface 103A of the base material 103, causing interference with a supporting jig 108 holding the base material 103. Thus, the sewing needle 101 may be easily broken or deformed.

Furthermore, when the sewing needle 101 is inserted at a slant through the front surface 103A of the base material 103, the sewing needle 101 is less apt to interfere with the supporting jig 108, but a clearance between the sewing needle 101 and an escape hole 108B of the supporting jig 108 may change. This makes it difficult to stably form a loop portion of a thread on a back surface 103B of the base material 103. Therefore, the thread forming the stitch pattern could not be stably fixed on the base material 103.

The present invention has been made to solve the above problems and has a purpose of preventing breakage, deformation, and other defects of a sewing needle through which a thread is inserted, even when the thread forming a stitch pattern is obliquely inserted into a front surface of a base material, and also enabling stable fixation of the thread forming the stitch pattern on the base material.

### Means of Solving the Problems

(1) To achieve the above purpose, one aspect of the invention provides an interior part including a base material and an outer skin material adhered to a front surface of the base material, in which the outer skin material includes a front surface formed with a stitch pattern of a thread inserted by engagement with a sewing needle to pass from the front surface of the outer skin material to a back surface of the base material to obliquely pass through the front surface of the base material, and a loop portion of the thread is fixed on the back surface of the base material, wherein the base material includes a seat surface for preventing slippage of the sewing needle on the front surface of the base material in a position where the thread of the stitch pattern is inserted.

(2) The interior part described in (1) preferably further includes a rubber member that can expand and contract and is located on the back surface of the base material or between the seat surface of the base material and the outer skin material so that the rubber member is placed in a position where the thread of the stitch pattern is inserted.

(3) In the interior part described in (1) or (2), preferably, the seat surface is a recess inclined at a predetermined inclination angle with respect to the front surface of the base material and continuously extended along a longitudinal direction of the stitch pattern.

(4) In the interior part described in (3), preferably, the inclination angle is set so that an insertion angle of the thread with respect to the seat surface falls within 90° plus or minus 30°.

(5) In a method for manufacturing the interior part described in one of (1) to (4), preferably, a stitching apparatus for producing the stitch pattern comprises: a thread supply device to be placed above the outer skin material, the thread supply device being configured to operate the sewing needle to supply the thread to the base material; and a supporting jig to be placed in contact with the back surface of the base material to hold the base material in a predetermined posture, the sewing needle includes an outer peripheral surface on a thread supply side and is formed, on the outer peripheral surface, with a thread groove extending in a needle axis direction to guide the thread, the supporting jig includes: a thread push surface to be placed in almost parallel to an outer peripheral surface of the sewing needle on the thread supply side in the needle axis direction and to be spaced with a minute clearance from the outer peripheral surface of the sewing needle when the sewing needle passes through the base material to the back surface; and a thread escape surface placed facing the thread push surface with respect to the sewing needle and configured to accommodate the loop portion of the thread, and the method includes inserting the sewing needle to the back surface of the base material and then retracting the sewing needle, so that the thread in the thread groove is pushed by the thread push surface toward an opposite side to the thread groove with respect to the needle axis, and the tread forms a loop portion between the sewing needle and the thread escape surface.

(6) In the method for manufacturing the interior part described in (5), preferably, the thread supply device includes an outer-skin-material pressing part having a needle insertion hole formed to allow the sewing needle to obliquely pass through the front surface of the base material, and the outer-skin-material pressing part is configured to restrict lateral movement of the sewing needle by the needle insertion hole during sewing.

(7) In the method for manufacturing the interior part described in (6), preferably, the needle insertion hole is formed with a hole center positioned eccentrically toward the thread groove with respect to the needle axis of the sewing needle so that a minute clearance is formed between an inner peripheral surface of the needle insertion hole and an outer peripheral surface of the sewing needle on an opposite side to the thread groove.

### Effects of the Invention

According to the invention, even when a thread forming a stitch pattern is inserted obliquely into a front surface of the base material, it is possible to prevent breakage, deformation, or other defects of a sewing needle through which the thread is inserted, and also stably fix the thread forming the stitch pattern on the base material.

### BRIEF DESCRIPTION OF THE DRAWINGS

FIG. 1 is a perspective view of an interior part in one example of an embodiment according to the invention;

FIG. 2 is a cross-sectional view of the interior part taken along an A-A line in FIG. 1, showing a stitch pattern in a first example;

FIG. 3 is a cross-sectional view taken along a line B-B in FIG. 2;

FIG. 4 is a partial cross-sectional view to explain a relationship between an inclination angle of a seat surface to a front surface of a base material and an insertion angle of a thread to the seat surface in FIG. 3, (a) showing a case where the insertion angle is 90° and (b) showing a case where the insertion angle is 110°;

FIG. 5 is a partial cross-sectional view of a stitching apparatus for manufacturing the interior part in the first example shown in FIG. 2;

FIG. 6 is a cross-sectional view taken along a line C-C in FIG. 5;

FIG. 7 is a view seen from an arrow D in FIG. 5;

FIG. 8 is a cross-sectional view of the interior part taken along a line A-A in FIG. 1, showing a stitch pattern in a second example;

FIG. 9 is a cross-sectional view taken along a line E-E in FIG. 8;

FIGS. 10 (a) and (b) are cross-sectional views of modified examples of a seat surface of FIG. 3, (a) showing an example that a front surface of a base material is formed with a wedge-shaped recessed surface by use of a leading needle and (b) showing an example that a front surface of a base material is formed to be rough by use of a file or the like or formed with minute asperity and projections; and

FIG. 11 is cross-sectional view showing a process of forming a stitch pattern in an outer edge of a base material in a decorative member described in Patent Document 1, (a) showing a case where a sewing needle is inserted in a direction perpendicular to a front surface of the base material and (b) showing a case where a sewing needle is inserted obliquely into a front surface of the base material.

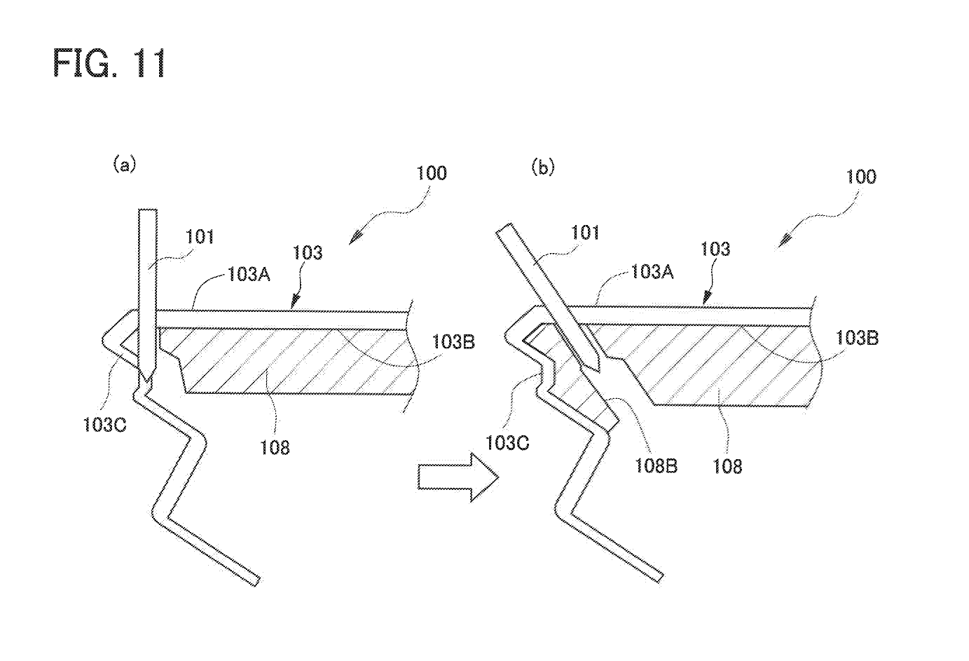

### MODE FOR CARRYING OUT THE INVENTION

A detailed description of a preferred embodiment of an interior part and a method for manufacturing the interior part embodying the present invention will now be given referring to the accompanying drawings. Firstly, the structure of the interior part provided with a stitch pattern in a first example according to the present embodiment will be described, followed by an explanation of a work process for forming the stitch pattern. Furthermore, the structure of an interior part provided with a stitch pattern in a second example according to the present embodiment will be explained.

### First Example

<Structure of Interior Part Provided with Stitch Pattern>

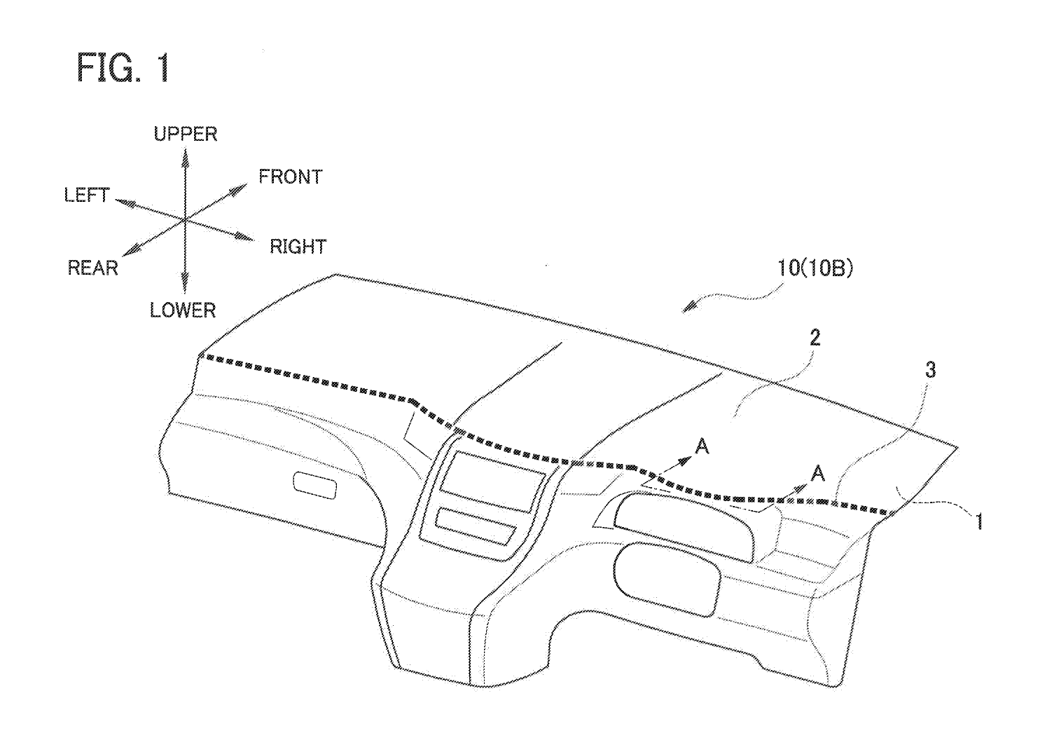

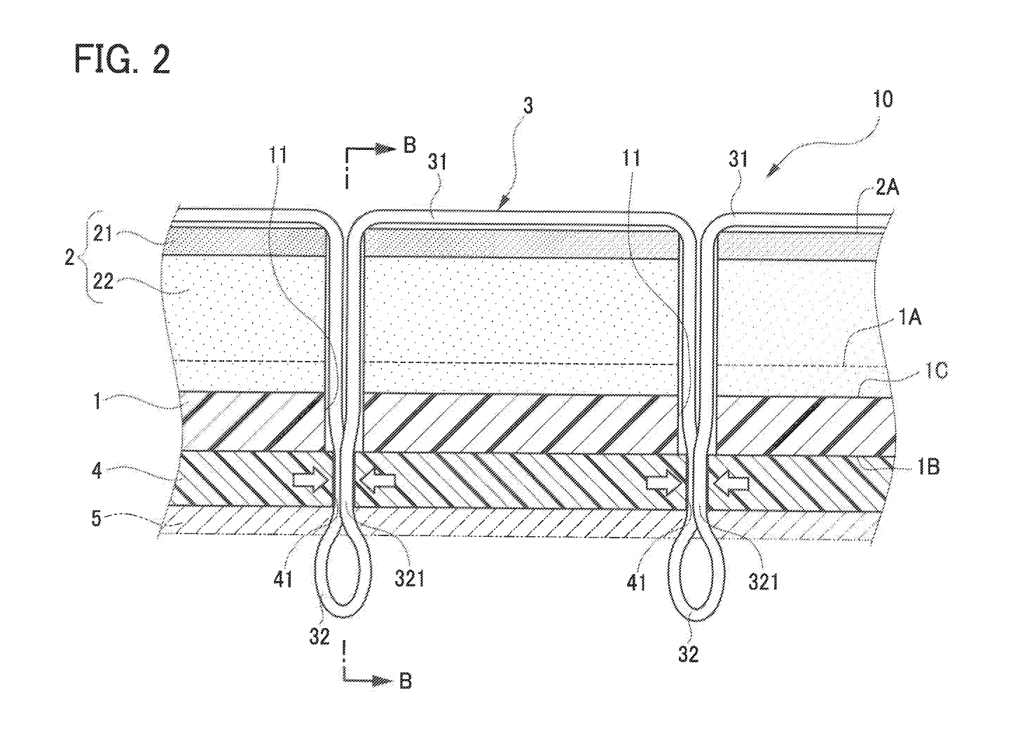

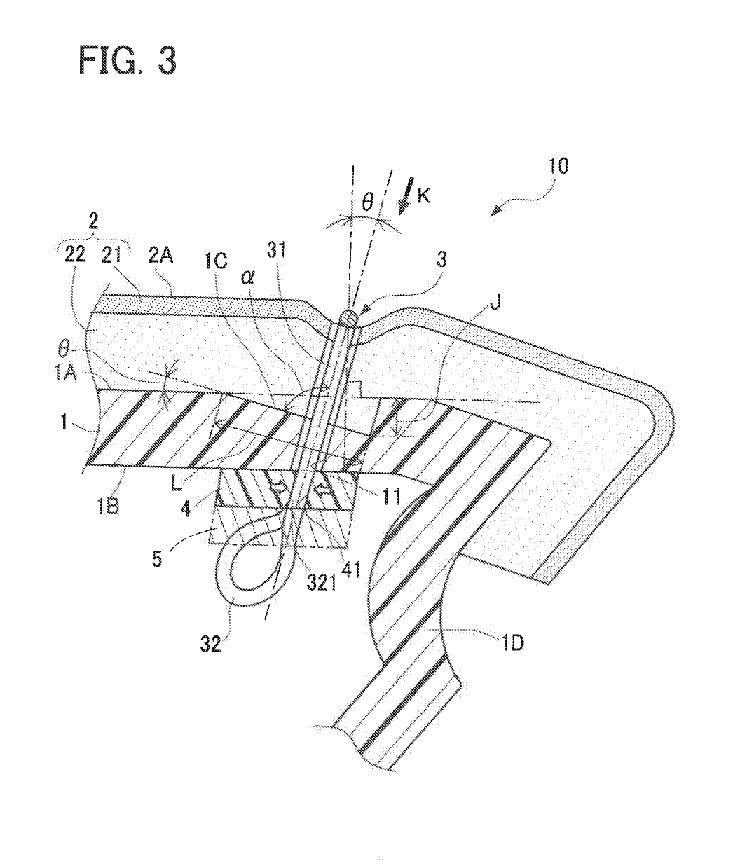

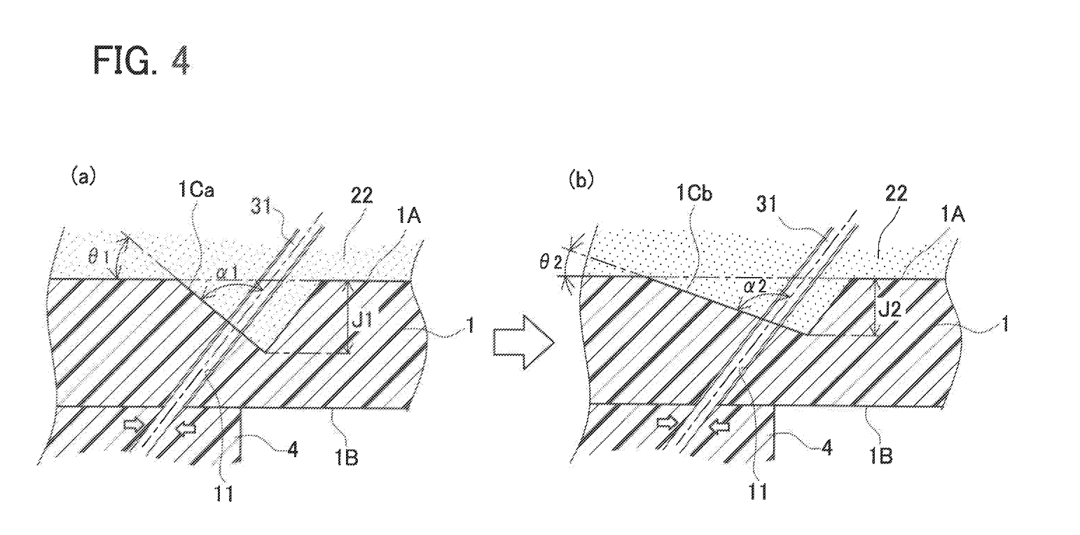

The structure of an interior part provided with a stitch pattern in the first example according to the present embodiment is described first, referring to FIGS. 1 to 4. FIG. 1 is a perspective view of an interior part which is one example of the present embodiment according to the invention. FIG. 2 is a cross-sectional view of the interior part taken along a line A-A in FIG. 1, showing a stitch pattern in the first example. FIG. 3 is a cross-sectional view taken along a line B-B in FIG. 2. FIG. 4 is a partial cross-sectional view to explain a relationship between an inclination angle of a seat surface to a front surface of a base material and an insertion angle of a thread to the seat surface in FIG. 3, (a) showing a case where the insertion angle is 90° and (b) showing a case where the insertion angle is 110°.

As shown in FIGS. 1 and 2, the interior part 10 in the present embodiment is for example an instrumental panel placed in front of a driver seat and a passenger seat in a vehicle. This interior part 10 includes a base material 1 made of rigid synthetic resin and formed in a desired shape and a soft outer skin material 2 adhered to a front surface 1A of the base material 1. The base material 1 is for example made of polypropylene (PP) by injection molding. The outer skin material 2 consists of an outer skin 21 having superior tractility placed on a front surface side and a foamed layer 22 placed on a base material side. The outer skin material 2 is bonded to the base material 1. The outer skin 21 is formed with a leathery embossed pattern to impart a sense of luxury and soft texture. The outer skin 21 is made for example of thermoplastic olefinic elastomer (TPO) having a thickness of the order of 0.5 mm to 0.8 mm. The foamed layer 22 is made for example of polypropylene foam (PPF) having a thickness of the order of 3 mm to 4 mm. The front surface of the outer skin material 2 is formed with a stitch pattern 3 with a thread 31 so that the stitch pattern 3 extends in right and left direction of a vehicle.

Further, a thread (an upper thread) 31 for the stitch pattern 3 is fixed to the base material 1 in such a way that the thread 31 is inserted together with a sewing needle from a front surface side of the outer skin material 2 to a back surface side of the base material 1, and then a loop portion 32 of the thread 31 formed when the sewing needle is retracted is bound by an expandable and contractible rubber member 4 placed on a back surface 1B of the base material 1. Specifically, the rubber member 4 through which the thread 31 is inserted by the sewing needle is placed on the back surface 1B of the base material 1. A thread insertion hole 41 pierced through the rubber member 4 by the sewing needle contracts in diameter, thereby binding a root portion 321 of the loop portion 32 of the thread 31 to fix the thread 31 forming the stitch pattern 3 to the base material 1. The thread 31 is for example a synthetic fiber with an outer diameter of the order of 0.5 to 0.8 mm, which is smaller than the inner diameter of the thread insertion hole 11 (e.g., 1.5 mm to 2.0 mm) pierced through the base material 1 by the sewing needle.

The rubber member 4 is for example a plate-like rubber body formed in a strip shape and made of nitrile butadiene rubber (NBR), chloroprene rubber (CR), ethylene-propylene diene monomer (EPDM) rubber, and the like, and preferably has a shore hardness (JIS K 6253) in a range of A60 to 80 and a thickness in a range of 1 to 3 mm. The rubber member 4 is a flat plate-like rubber body having the predetermined hardness and thickness, and needs not to be formed in advance to conform to the shape of a back surface of the base material 1. The rubber member 4 is simply placed in contact with the back surface of the base material 1, and also needs not to be adhered to the back surface of the base material 1. For a plate-like rubber body made of ethylene-propylene diene monomer (EPDM) rubber, it is preferable to set the shore hardness (JIS K 6253) in a range of A70 to 80 and the thickness in a range of 1 to 2 mm.

The loop portion 32 is preferably adhered to the rubber member 4 with an adhesive 5 applied on a back surface of the rubber member 4 after the stitch pattern 3 is sewn. This is because the power of binding the thread 31, which results from expansion and contraction of the thread insertion hole 41, can be reinforced by the adhesive power of the adhesive 5 to address aged deterioration of the material of the rubber member 4, hardness change with temperature, and others. The reason to adhere the loop portion 32 to the back surface of the rubber member 4 after sewing of the stitch pattern 3 is as follows. If adhesion of the loop portion 32 is made before sewing of the stitch pattern 3, the adhesive 5 likely sticks to the sewing needle 7, causing a great increase in insertion resistance of the sewing needle 71 when passing through the base material 1. The adhesive 5 used in the present embodiment is for example a coating-type adhesive. As an alternative, the adhesive 5 may be an adhesive tape.

As shown in FIGS. 1 to 3, the interior part 10 includes the base material 1 and the outer skin material 2 adhered to the front surface 1A of the base material 1. This interior part 10 is provided with the stitch pattern 3 of the thread 31 on the front surface 2A of the outer skin material 2, the stitch pattern 3 being formed such that the loop portion 32 of the thread 31 obliquely inserted into the front surface 1A of the base material 1 by engagement with the sewing needle to pass from the front surface 2A of the outer skin material 2 to the back surface 1B of the base material 1, and then fixed on the back surface 1B of the base material 1.

On the front surface 1A of the base material 1, a seat surface 1C for preventing slippage of a sewing needle is formed in a position through which the thread 31 for forming the stitch pattern 3 passes. The seat surface 1C is formed as a recess inclined at a predetermined inclination angle θ with respect to the front surface 1A of the base material 1 and continuously extended along a longitudinal direction of the stitch pattern 3. The inclination angle θ is inclined toward a direction to separate a sewing needle which forms a thread insertion hole 11 by at least about 2 to 3 mm or more from an outer edge rib 1D formed on an outer ridge of the base material 1. The seat surface 1C is formed as a flat continuous surface extending in the longitudinal direction of the stitch pattern 3 and with a width L which is almost constant in the longitudinal direction of the stitch pattern 3.

The inclination angle θ is set so that an insertion angle α of the thread 31 with respect to the seat surface 1C falls within 90° plus or minus 30°. Herein, the insertion angle α of the thread 31 is set to about 90°. The insertion angle α of the thread 31 is preferably about 90° from the viewpoint of prevention of slippage of a sewing needle. The maximum recess depth J of the seat surface 1C with respect to the front surface 1A of the base material 1 is preferably one-half or less of the thickness of the base material 1 from the viewpoint of strength of the base material 1. Accordingly, for example, if the insertion angle α of the thread 31 is set to 900 with respect to a seat surface 1Ca as shown in FIG. 4(a), resulting in that a large inclination angle θ1 of the seat surface 1Ca with respect to a front surface 1A of the base material 1 and hence a maximum recess depth J1 is one-half or more of the thickness of the base material 1, an inclination angle θ2 of a seat surface 1Cb with respect to the front surface 1A of the base material 1 is set to be small so that an insertion angle α2 of the thread 31 with respect to the seat surface 1Cb is 1100 (90° or more, but 120° or less) as shown in FIG. 4(b). Accordingly, a maximum recess depth J2 of the seat surface 1Cb with respect to the front surface 1A of the base material 1 decreases, thereby enabling effective avoidance of slippage of a tip of a sewing needle while diminishing local thinning of the base material 1.

In order to reduce the maximum recess depth of the seat surface 1C with respect to the front surface 1A of the base material 1, a part of the seat surface 1C may be formed to protrude from the front surface 1A of the base material 1. Furthermore, the back surface 1B of the base material 1 may be formed in substantially parallel to the seat surface 1C to provide almost uniform thickness of the base material 1.

<Machining Sequence for Stitch Pattern>

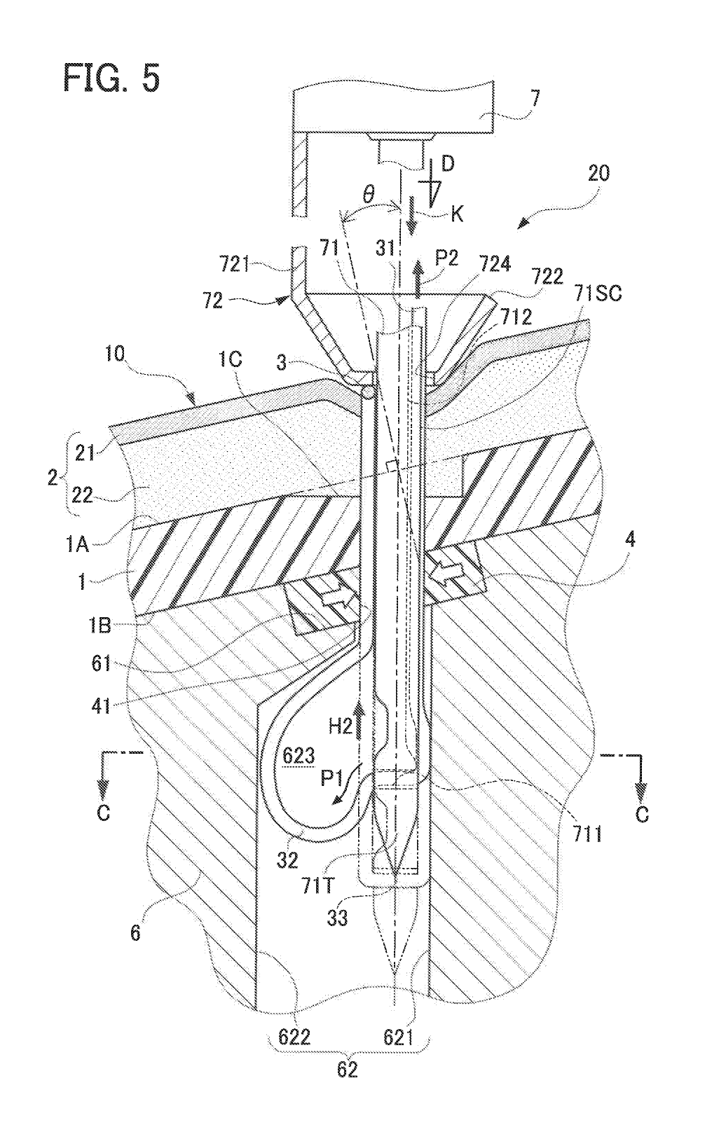

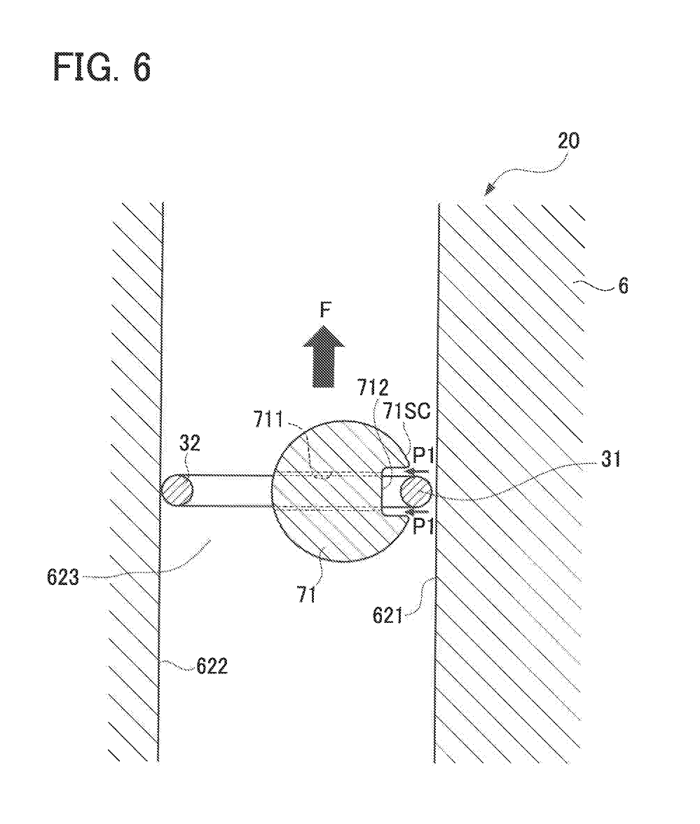

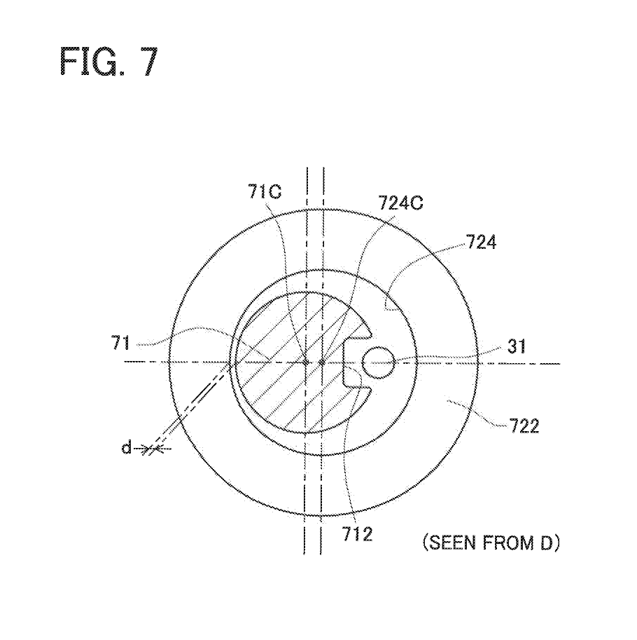

A machining sequence to form a stitch pattern on an interior part in the present embodiment will be described referring to FIGS. 5 to 7. FIG. 5 is a partial cross-sectional view of a stitching apparatus for manufacturing an interior part in a first example shown in FIG. 2. FIG. 6 is a cross-sectional view taken along a line C-C in FIG. 5. FIG. 7 is a view seen from an arrow D in FIG. 5.

As shown in FIGS. 5 to 7, a stitching apparatus 20 for forming the stitch pattern 3 of the interior part 10 in the present embodiment includes a thread supply device 7 that is to be placed above the outer skin material 2 and is configured to operate a sewing needle 71 to supply a thread 31 to the base material 1, and a supporting jig 7 to be placed in contact with the back surface 1B of the base material 1 to hold the base material 1 in a predetermined posture. The sewing needle 71 includes an outer peripheral surface 71SC on a thread supply side and is formed, on the outer peripheral surface 71SC, with a thread groove 712 extending in a needle axis direction to guide the thread 31. The supporting jig 6 includes a thread push surface 621 to be located in almost parallel to the outer peripheral surface 71SC of the sewing needle 71 on the thread supply side in the needle axial direction and to be spaced with a minute clearance from the outer peripheral surface 71SC of the sewing needle 71 when the sewing needle 71 passes through the base material 1 to the back surface 1B side, and a thread escape surface 622 located facing the thread push surface 621 with respect to the sewing needle 71 and configured to accommodate the loop portion 32 of the thread 31. Further, the sewing needle 71 is further formed, at its tip portion 71T, with a thread hole (a needle eyelet) 711 through which the thread (an upper thread) 31 is engaged (inserted). A thread groove 712 is formed to extend from the thread hole 711 toward a needle base end.

Herein, the depth of the thread groove 712 is preferably almost equal to the outer diameter of the thread 31. Further, the minute clearance between the outer peripheral surface 71SC of the sewing needle 71 on the thread supply side and the thread push surface 621 is preferably a distance enough to avoid interference therebetween and equal to or less than the outer diameter of the thread 31 and, more preferably, a distance corresponding to about 1 to 0.7 times larger than the outer diameter of the thread 31.

The supporting jig 6 is formed with a rubber holding seat 61 for positioning the strip-shaped rubber member 4 extending along the stitch pattern 3. Under the rubber holding seat 61, an escape part 62 is formed with a predetermined width along the stitch pattern 3. This escape part 62 is defined by the thread push surface 621 and the thread escape surface 622. The thread supply device 7 can be attached to a distal end of an arm of a multi-joint robot not shown and thus is movable to a necessary position and at a necessary angle with respect to the base material 1 to form the stitch pattern 3.

The thread supply device 7 includes an outer-skin-material pressing part 72 having a needle insertion hole 724 formed to allow the sewing needle 71 to obliquely pass through the front surface 1A of the base material 1. This needle insertion hole 724 serves to restrict lateral movement of the sewing needle 71 during sewing. The outer-skin-material pressing part 72 includes a support part 721 provided upright in an apparatus main body, and a pressing part 722 formed in an almost conical shape on a tip side of the support part 721 to press the outer skin material 2 on an outer circumferential side of the sewing needle 71. The pressing part 722 is formed to be located on a more front side than the tip of the sewing needle 71 after the sewing needle 71 is retracted. The pressing part 722 is formed, at its center, with the needle insertion hole 724 to allow the sewing needle 71 and the thread 31 on the thread supply side to pass through. Herein, a hole center 724C of the needle insertion hole 724 is eccentrically positioned toward the thread groove 712 with respect to the needle axis 71C, so that a minute clearance d (the order of 0 to 0.1 mm) is formed between the inner peripheral surface of the needle insertion hole 724 and the outer peripheral surface of the sewing needle 71 on an opposite side to the thread groove 712. Accordingly, during sewing, the inner peripheral surface of the needle insertion hole 724 restricts the sewing needle 71 from moving to the opposite side to the thread groove 712. The needle insertion hole 724 may be perfectly circular or elliptical. Furthermore, the hole center 724C of the needle insertion hole 724 may be eccentric to the center of the pressing part 722.

The thread supply device 7 is operative to insert the thread 31 engaged in the thread hole 711 from the front surface 2A side of the outer skin material 2 to the back surface side of the rubber member 4, together with the sewing needle 71, and then retract the thread 31 to the front surface 2A side of the outer skin material 2 and move the sewing needle 71 and the thread 31 to a next sewing position. In the course of retracting the sewing needle 71 inserted to the back surface side of the rubber member 4, the thread 31 located in the thread groove 712 is pushed by the thread push surface 621 to an opposite side to the thread groove 712 with respect to the needle axis to form the thread loop portion 32 between the sewing needle 71 and the thread escape surface 622.

To be concrete, as shown in FIG. 5, when the sewing needle 71 having the thread 31 engaged in the thread hole 711 is inserted obliquely (at an inclination angle θ to a normal line direction) into the front surface 1A of the base material 1 (into a state indicated with an imaginary line) from the front surface side of the outer skin material 2 to an insertion end on the back surface side of the rubber member 4 and then the sewing needle 71 is retracted upward (in a direction of an arrow H2), the thread 31 in the thread groove 712 on the thread supply side is pushed by the thread push surface 621 toward the opposite side to the thread groove 712 (in a direction of an arrow P1) through the thread hole 711. Then, the sewing needle 71 is retracted while holding the thread 31 on the thread supply side in the thread groove 712. Thus, even when the thread insertion hole 41 of the rubber member 4 contracts, friction resistance hardly acts on the thread 31. Therefore, the thread 31 on the thread supply side is easily wound back upwardly (in a direction of an arrow P2), forming no thread loop portion.

In contrast, on an opposite side to the thread supply side, when the thread insertion hole 41 of the rubber member 4 contracts in diameter, friction resistance acts between the thread insertion hole 41 of the rubber member 4 and the thread 31, thereby restricting upward movement of the thread 31. Accordingly, when the sewing needle 71 is retracted upward, the loop portion 32 of the thread 31 is formed only inside a loop accommodating space 623 formed between the sewing needle 71 and the thread escape surface 622. On the back surface side of the rubber member 4, therefore, the loop portion 32 of the thread 31 is formed stably only on the opposite side to the thread supply side. Since the loop portion 32 of the thread 31 is formed stably only on the opposite side to the thread supply side, it is possible to prevent the loop portion 32 of the thread 31 from slipping out from the back surface 1B side of the base material 1.

Consequently, even when the stitch pattern 3 is formed near an outer edge of the base material 1, the sewing needle 71 does not need to be inserted into the front surface 1A of the base material 1 in a direction perpendicular to the front surface 1A. This can avoid the tip of the sewing needle 71 from interfering with an outer edge rib and others formed on the outer edge of the base material 1 and also stably form the loop portion 32 of the thread 31 on the back surface 1B side of the base material 1. Furthermore, the thread 31 forming the stitch pattern 3 can be stably fixed to the base material 1 and also breakage or deformation of the sewing needle 71 can be prevented.

### Second Example

<Structure of Interior Part Provided with Stitch Pattern>

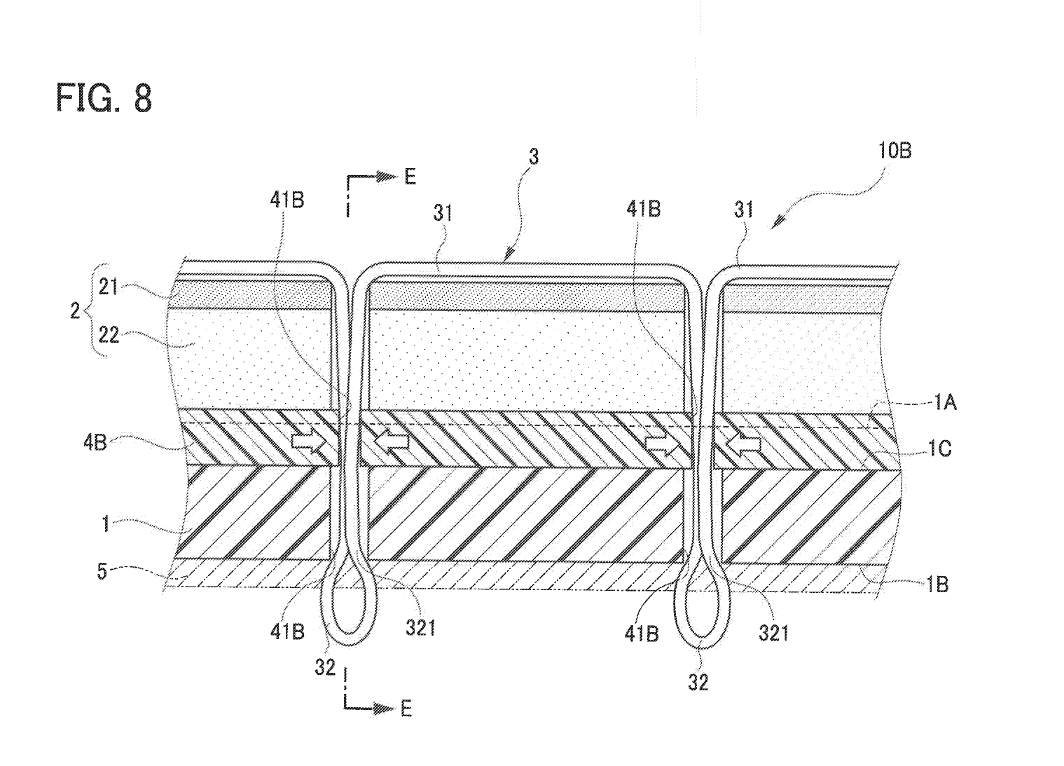

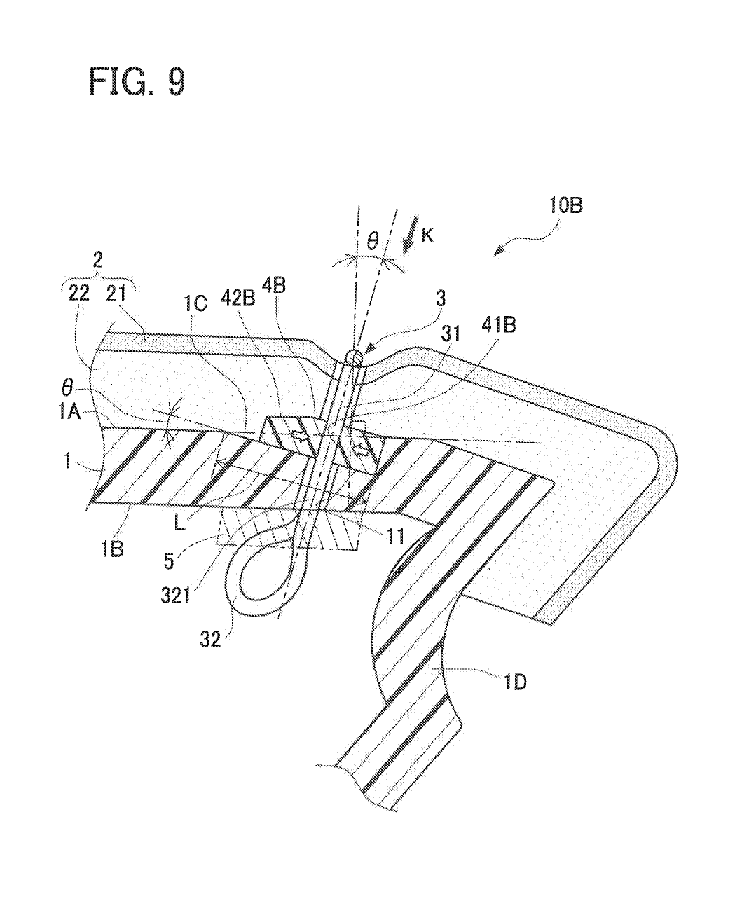

The structure of an interior part provided with a stitch pattern in a second example according to the present invention will be described below referring to FIGS. 8 and 9. FIG. 8 is a cross-sectional view of the interior part taken along the line A-A in FIG. 1, showing a stitch pattern of the second embodiment. FIG. 9 is a cross-sectional view taken along a line E-E in FIG. 8.

As shown in FIGS. 8 and 9, an interior part 10B in the present example is identical in structure to that in the first example, excepting a rubber member 4B. Accordingly, for the common parts to the first example are assigned the same reference signs and their explanations are basically omitted. The following explanation is given in detail to the features of the rubber member 4B different from the first example. A machining sequence for the stitch pattern 3 in the interior part 10B is the same as that in the aforementioned first example.

In the second example, the rubber member 4B that can expand and contract is provided between the seat surface 1C and the outer skin material 2 and in a position where the thread 31 of the stitch pattern 3 is to be inserted. The rubber member 4B has a shape smaller in width than the width L of the seat surface 1C and continuous along the longitudinal direction of the stitch pattern 3. The rubber member 4B is formed as a plate-like body having a predetermined thickness. However, to avoid an excessive compression amount of the foamed layer 22 of the outer skin material 2, preferably, a chamfered portion 42B is formed on an upper side to reduce a protruding amount of the rubber member 4B from the front surface 1A of the base material 1.

The thread 31 (an upper thread) for the stitch pattern 3 is fixed to the base material 1 in such a way that the thread 31 is inserted together with the sewing needle from the front surface side of the outer skin material 2 to the back surface 1B side of the base material 1, and the loop portion 32 of the thread 31 formed when the sewing needle is retracted is bound by the rubber member 4B provided between the seat surface 1C and the outer skin material 2. Specifically, the rubber member 4B through which the thread 31 is inserted by the sewing needle is placed between the seat surface 1C and the outer skin material 2. The thread insertion hole 41B pierced through the rubber member 4B by the sewing needle contracts in diameter, thereby binding the root portion 321 of the loop portion 32 of the thread 31 to fix the thread 31 forming the stitch pattern 3 to the base material 1.

In the second example, the rubber member 4B that can expand and contract is placed between the seat surface 1C and the outer skin material 2. This configuration increases the design freedom to provide strengthening ribs, mounting seats for mounting other components, and others, which are not shown, onto the back surface 1B of the base material 1. Further, the thread loop portion 32 can be fixed to the base material 1 with the adhesive 5 or the like applied to the back surface 1B of the base material 1 after the stitch pattern 3 is sewn.

### Operations and Advantageous Effects

As described in detail above, according to the interior part 10 or 10B in the present embodiment, the base material 1 includes the seat surface 1C for preventing slippage of the sewing needle 71 on the front surface 1A of the base material 1 in a position where the thread 31 of the stitch pattern 3 is inserted. Accordingly, even when the sewing needle 71 with the thread 31 engaged therein is obliquely inserted into the front surface 1A of the base material 1, the tip of the sewing needle 71 is less likely to slip on the front surface 1A of the base material 1 and can maintain an almost constant clearance between the sewing needle 71 and the escape part 62 of the supporting jig 6. The loop portion 32 of the thread 31 can thus be stably formed on the back surface 1B of the base material 1. The above configuration also can effectively avoid interference between the sewing needle 71 and the supporting jig 6.

Even when the stitch pattern 3 is formed near the outer edge of the base material 1, the sewing needle 71 can be obliquely inserted into the front surface 1A of the base material 1. Thus, the tip of the sewing needle 71 can avoid interference with the outer edge rib 1D and others formed on the outer edge of the base material 1. Accordingly, the loop portion 32 of the thread 31 can be stably formed on the back surface 1B of the base material 1. The thread 31 of the stitch pattern 3 can be stably fixed to the base material 1 and also breakage or deformation of the sewing needle 71 can be prevented.

According to the present embodiment, therefore, even when the thread 31 of the stitch pattern 3 is obliquely inserted into the front surface 1A of the base material 1, it is possible to prevent breakage or deformation of the sewing needle 71 in which the thread 31 is inserted and also stably fix the thread 31 of the stitch pattern 3 to the base material 1.

According to the present embodiment, furthermore, the interior part further includes the rubber member 4 or 4B that can expand and contract and is located on the back surface 1B of the base material 1 or between the seat surface 1C and the outer skin material 2 so that the rubber member is placed in a position where the thread 31 of the stitch pattern 3 is inserted. Thus, the thread insertion hole 41 or 41B pierced through the rubber member 4 or 4B by the sewing needle 71 contracts in diameter, thereby binding the root portion 321 of the loop portion 32 of the thread 31 to prevent the thread 31 from slipping off from the base material 1. Even when the sewing needle 71 having the thread 31 engaged therein is obliquely inserted into the front surface 1A of the base material 1, it is possible to prevent the thread 31 from slipping out and stably form the loop portion 32 of the thread 31 on the back surface 1B of the base material 1, and also stably fix the thread 31 of the stitch pattern 3 to the base material 1. When the expandable and contractible rubber member 4B is placed between the seat surface 1C and the outer skin material 2, this configuration can enhance the design freedom to provide strengthening ribs, mounting seats for mounting other components, and others to the back surface 1B of the base material 1.

According to the present embodiment, the seat surface 1C is a recess inclined at a predetermined inclination angle θ with respect to the front surface 1A of the base material 1 and continuously extended along the longitudinal direction of the stitch pattern 3. Thus, the seat surface 1C can be a flat recessed continuous surface extending in the longitudinal direction of the stitch pattern 3. This can suppress a part of the thread 31 placed on the front surface 1A of the base material 1 from floating. Accordingly, the loop portion 32 of the thread 31 can be formed with a stable size on the back surface 1B of the base material 1 and thus the thread 31 of the stitch pattern 3 can be more stably fixed to the base material 1.

According to the present embodiment, furthermore, the inclination angle θ is set so that the insertion angle α of the thread 31 with respect to the seat surface 1C falls within 90° plus or minus 30°. Accordingly, the maximum recess depth J of the base material 1 by the seat surface 1C can be restricted, thereby diminishing local thinning of the base material 1. Furthermore, since the insertion angle α of the thread 31 with respect to the seat surface 1C is within 90° plus or minus 30°, the tip of the sewing needle 71 can be effectively prevented from slipping on the seat surface 1C. This makes it possible to achieve the strength of the base material 1 at a predetermined level and also form the loop portion 32 of the thread 31 with a stable size on the back surface 1B of the base material 1, thereby allowing the thread 31 of the stitch pattern 3 to be stably fixed to the base material 1.

According to the method for manufacturing the interior part in another embodiment, the stitching apparatus 20 for producing the stitch pattern 3 includes: the thread supply device 7 that is to be placed above the outer skin material 2 and is configured to operate the sewing needle 71 to supply the thread 31 to the base material 1; and the supporting jig 6 to be placed in contact with the back surface 1B of the base material 1 to hold the base material 1 in a predetermined posture. The sewing needle 71 includes the outer peripheral surface 71SC on the thread supply side and is formed, on the outer peripheral surface 71SC, with the thread groove 712 extending in the needle axis direction to guide the thread 31. The supporting jig 6 includes: the thread push surface 621 that is placed in almost parallel to the outer peripheral surface of the sewing needle 71 on a thread supply side in the needle axis direction and is spaced with a minute clearance from the outer peripheral surface of the sewing needle 71 when the sewing needle 71 passes through the base material 1 to the back surface 1B; and the thread escape surface 622 placed facing the thread push surface 621 with respect to the sewing needle 71 and configured to accommodate the loop portion 32 of the thread 31. When the sewing needle 71 is inserted to and then retracted from the back surface 1B of the base material 1, the thread 31 in the thread groove 712 is pushed by the thread push surface 621 toward an opposite side to the thread groove 712 with respect to the needle axis, and the thread 31 forms the loop portion 32 between the sewing needle 71 and the thread escape surface 622. Accordingly, even when the sewing needle 71 is obliquely inserted into the front surface 1A of the base material 1, the loop portion 32 of the thread 31 is stably formed only on an opposite side to the thread supply side of the sewing needle 71. Thus, the loop portion 32 of the thread 31 can be prevented from slipping off from the back surface 1B side of the base material 1 toward the front surface 1A side of the base material 1. Consequently, it is possible to avoid interference between the tip of the sewing needle 71 and the supporting jig 6 holding the base material 1 and also stably form the loop portion 32 of the thread 31 on the back surface 1B of the base material 1, so that the thread 31 of the stitch pattern 3 can be stably fixed to the base material 1.

According to the second embodiment, therefore, even when the thread 31 of the stitch pattern 3 is obliquely inserted into the front surface 1A of the base material 1, it is possible to prevent breakage or deformation of the sewing needle 71 having the thread 31 inserted therein and also reliably fix the thread 31 of the stitch pattern 3 to the base material 1.

According to the second embodiment, the thread supply device includes the outer-skin-material pressing part 72 having the needle insertion hole 724 formed to allow the sewing needle to obliquely pass through the front surface 1A of the base material 1, and the outer-skin-material pressing part 72 is configured to restrict lateral movement of the sewing needle 71 by the needle insertion hole 724 during sewing. Thus, even when the sewing needle 71 is obliquely inserted into the front surface 1A of the base material 1, slippage of the tip of the sewing needle 71 on the front surface 1A of the base material 1 can be more reliably prevented. It is therefore possible to avoid the sewing needle 71 from interfering with the supporting jig 6 holding the base material 1 and hence from easily becoming broken or deformed.

According to the second embodiment, moreover, lateral movement of the sewing needle 71 is restricted by the needle insertion hole 724 during sewing. Thus, even when the sewing needle 71 is obliquely inserted into the front surface 1A of the base material 1, the minute clearance between the thread push surface 621 and the outer peripheral surface 71SC of the sewing needle 71 on the thread groove 712 side is less likely to change. Accordingly, the thread 31 located inside the thread groove 712 can be more stably pushed to the opposite side to the thread groove 712 with respect to the needle axis. Consequently, on the back surface 1B of the base material 1, the loop portion 32 of the thread 31 is stably formed only on the opposite side of the sewing needle 71 formed with the thread groove 712 to the thread supply side. This can further prevent the loop portion 32 of the thread 31 from coming off from the back surface 1B side of the base material 1 toward the front surface side 1A of the base material 1. It is therefore possible to avoid interference between the sewing needle 71 and the supporting jig 6 and also stably form the loop portion 32 of the thread 31 on the back surface 1B of the base material 1, so that the thread 31 of the stitch pattern 3 can be more stably fixed to the base material 1.

According to the second embodiment, the needle insertion hole 724 is formed with a hole center 724C positioned eccentrically toward the thread groove 712 with respect to the needle axis 71C of the sewing needle 71 so that the minute clearance d is formed between the inner peripheral surface of the needle insertion hole 724 and the outer peripheral surface of the sewing needle 71 on the opposite side to the thread groove 712. Accordingly, the inner peripheral surface of the needle insertion hole 724 can prevent the sewing needle 71 from moving to the opposite side to the thread groove 712 during sewing. On the back surface 1B of the base material 1, the loop portion 32 of the thread 31 is more stably formed only on the opposite side of the sewing needle 71 to the thread supply side. Since the loop portion 32 of the thread is stably formed only on the opposite side of the sewing needle 71 to the thread supply side, it is possible to further prevent the loop portion 32 of the thread 31 from coming off from the back surface 1B side of the base material 1 toward the front surface 1A side of the base material 1.

### Modified Example

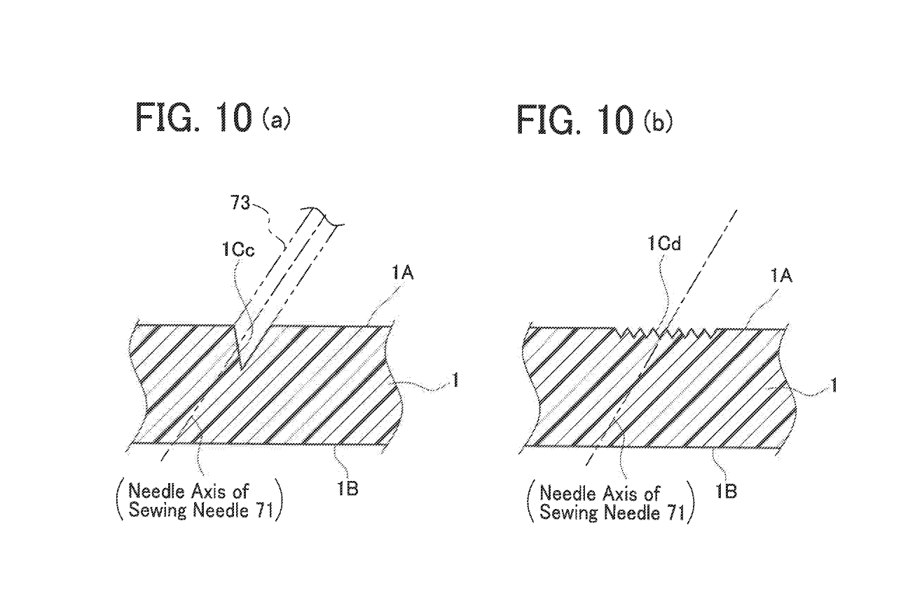

The present invention may be embodied in other specific forms without departing from the essential characteristics thereof. For instance, according to the interior part 10 or 10B in the present embodiment, the seat surface 1C is formed as a recess inclined at the inclination angle θ with respect to the front surface 1A of the base material 1 and continuously extended along the longitudinal direction of the stitch pattern 3. However, the present invention is not necessarily limited to the above configurations. The seat surface 1C has only to be formed to provide a function to prevent slippage of the tip of the sewing needle 71, and may be formed with a wedge-shaped recessed surface 1Cc on the front surface 1A of the base material 1 by use of a leading needle 73 as shown in FIG. 10(a) or may be formed into a rough surface or a micro-asperity surface 1Cd by use of a file or the like as shown in FIG. 10(b).

### INDUSTRIAL APPLICABILITY

The present invention is applicable to an interior part including a base material and an outer skin material adhered to a front surface of the base material, and formed with a stitch pattern on the front surface of the outer skin material, and a method for manufacturing the interior part.

### REFERENCE SIGNS LIST

1 Base material
1A Front surface
1B Back surface
1C Seat surface
2 Outer skin material
3 Stitch pattern
4, 4B Rubber member
5 Adhesive
6 Supporting jig
7 Thread supply device
10, 10B Interior part
20 Stitching apparatus
31 Thread (Upper thread)
32 Loop portion
41, 41B Needle eyelet
71 Sewing needle
71SC Outer peripheral surface
72 Outer-skin-material pressing part
621 Thread push surface
622 Thread escape surface
712 Thread groove
724 Needle insertion hole
θ Inclination angle
α Insertion angle

1. An interior part including a base material and an outer skin material adhered to a front surface of the base material, in which the outer skin material includes a front surface formed with a stitch pattern of a thread inserted by engagement with a sewing needle to pass from the front surface of the outer skin material to a back surface of the base material to obliquely pass through the front surface of the base material, and a loop portion of the thread is fixed on the back surface of the base material,
wherein the base material includes a seat surface for preventing slippage of the sewing needle on the front surface of the base material in a position where the thread of the stitch pattern is inserted.

2. The interior part according to claim 1, further including a rubber member that can expand and contract and is located on the back surface of the base material or between the seat surface of the base material and the outer skin material so that the rubber member is placed in a position where the thread of the stitch pattern is inserted.

3. The interior part according to claim 1, wherein the seat surface is a recess inclined at a predetermined inclination angle with respect to the front surface of the base material and continuously extended along a longitudinal direction of the stitch pattern.

4. The interior part according to claim 3, wherein the inclination angle is set so that an insertion angle of the thread with respect to the seat surface falls within 90° plus or minus 30°.

5. A method for manufacturing the interior part according to claim 1, wherein
a stitching apparatus for producing the stitch pattern comprises: a thread supply device to be placed above the outer skin material, the thread supply device being configured to operate the sewing needle to supply the thread to the base material; and a supporting jig to be placed in contact with the back surface of the base material to hold the base material in a predetermined posture,
the sewing needle includes an outer peripheral surface on a thread supply side and is formed, on the outer peripheral surface, with a thread groove extending in a needle axis direction to guide the thread,
the supporting jig includes: a thread push surface to be placed in almost parallel to an outer peripheral surface of the sewing needle on the thread supply side in the needle axis direction and to be spaced with a minute clearance from the outer peripheral surface of the sewing needle when the sewing needle passes through the base material to the back surface; and a thread escape surface placed facing the thread push surface with respect to the sewing needle and configured to accommodate the loop portion of the thread, and
the method includes inserting the sewing needle to the back surface of the base material and then retracting the sewing needle, so that the thread in the thread groove is pushed by the thread push surface toward an opposite side to the thread groove with respect to the needle axis, and the tread forms a loop portion between the sewing needle and the thread escape surface.

6. The method for manufacturing the interior part according to claim 5, wherein the thread supply device includes an outer-skin-material pressing part having a needle insertion hole formed to allow the sewing needle to obliquely pass through the front surface of the base material, and the outer-skin-material pressing part is configured to restrict lateral movement of the sewing needle by the needle insertion hole during sewing.

7. The method for manufacturing the interior part according to claim 6, wherein the needle insertion hole is formed with a hole center positioned eccentrically toward the thread groove with respect to the needle axis of the sewing needle so that a minute clearance is formed between an inner peripheral surface of the needle insertion hole and an outer peripheral surface of the sewing needle on an opposite side to the thread groove.
